(19) United States
(12) Patent Application Publication
(10) Pub. No.: US 2023/0237296 A1
(43) Pub. Date: Jul. 27, 2023

(54) BARCODE SCANNER INTEGRATION WITH A WEB APPLICATION

(71) Applicant: QUANTUMSCAPE BATTERY, INC., San Jose, CA (US)

(72) Inventor: Thirulogachandar K. Medampalli, Cupertino, CA (US)

(21) Appl. No.: 18/159,531

(22) Filed: Jan. 25, 2023

Related U.S. Application Data
(60) Provisional application No. 63/302,950, filed on Jan. 25, 2022.

(51) Int. Cl. G06K 19/06; G06K 7/10

(52) U.S. Cl. CPC G06K 19/06018; G06K 7/1095

(57) ABSTRACT

Systems, methods, apparatuses, and computer program products for using a web browser extension or plug-in component to receive scanned barcode data. One method may include validating, by a computing device, machine-readable data, generating, by a computing device, at least one event based upon the validated machine-readable data, and publishing, by the computing device, the at least one event according to a rendering component.

### CROSS-REFERENCE TO RELATED APPLICATIONS

This application claims priority to, and the benefit of, U.S. Provisional Patent Application No. 63/302,950, filed Jan. 25, 2022, the entire contents of which is incorporated by reference in its entirety for all purposes.

### TECHNICAL FIELD

Some example embodiments may generally relate to barcode scanners interfaced with a web browser. For example, certain example embodiments may relate to systems and/or methods for using a web browser extension or plug-in component to receive scanned barcode data.

### BACKGROUND

Barcodes provide a visual representation of data in a format that can be detected and interpreted by a machine, such as an optical scanner. Barcodes can convey a variety of types of data, such as serial number, price, product code, tracking number, and International Standard Book Number. Barcodes may also utilize a check digit (i.e., checksum) to detect errors and misreads by the scanner.

### SUMMARY

In accordance with some example embodiments, a method may include validating, by a computing device, barcode data. The method may further include generating, by a computing device, at least one event based upon the validated barcode data. The method may further include publishing, by the computing device, the event based according to a rendering component.

In accordance with certain example embodiments, an apparatus may include means for validating barcode data. The apparatus may further include means for generating at least one event based upon the validated barcode data. The apparatus may further include means for publishing the event based according to a rendering component.

In accordance with various example embodiments, a non-transitory computer readable medium may be encoded with instructions that may, when executed in hardware, perform a method. The method may include validating barcode data. The method may further include generating at least one event based upon the validated barcode data. The method may further include publishing the event based according to a rendering component.

In accordance with some example embodiments, a computer program product may perform a method. The method may include validating barcode data. The method may further include generating at least one event based upon the validated barcode data. The method may further include publishing the event based according to a rendering component.

In accordance with certain example embodiments, an apparatus may include at least one processor and at least one memory including computer program code. The at least one memory and the computer program code may be configured to, with the at least one processor, cause the apparatus to at least validate barcode data. The at least one memory and the computer program code may be further configured to, with the at least one processor, cause the apparatus to at least generate at least one event based upon the validated barcode data. The at least one memory and the computer program code may be further configured to, with the at least one processor, cause the apparatus to at least publish the event based according to a rendering component.

In accordance with various example embodiments, an apparatus may include circuitry configured to validate barcode data. The circuitry may further be configured to generate at least one event based upon the validated barcode data. The circuitry may further be configured to publish the event based according to a rendering component.

### BRIEF DESCRIPTION OF THE DRAWINGS

For proper understanding of example embodiments, reference should be made to the accompanying drawings, wherein:

FIG. 1 illustrates an example of a system according to certain example embodiments.

FIG. 2 illustrates an example of a flow diagram of a method according to some example embodiments.

### DETAILED DESCRIPTION

Certain example embodiments described herein may have various benefits and/or advantages to overcome the disadvantages in the prior art. For example, certain example embodiments may utilize a web application which is easy to update, adjust the functionality, and/or upgrade through a single portal. Thus, certain example embodiments discussed below are directed to improvements in computer-related technology.

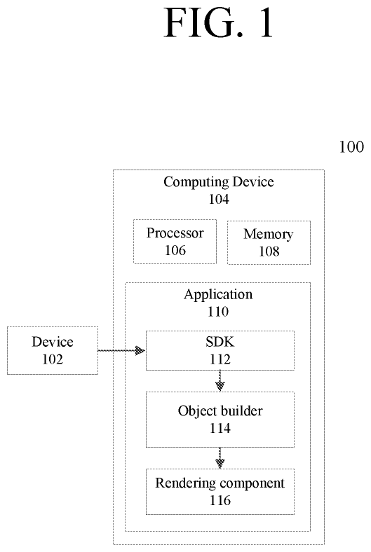

FIG. 1 illustrates an example embodiment of a system architecture 100 which may integrate a barcode scanner with a web application. In particular, the system may enable a web application to access resources on a computing device using a scanning device, and improve processes such as ordering products, cycle counting, and moving inventory within a warehouse.

Device 102 may be used by a user to scan any type of machine-readable data. In some example embodiments, the machine-readable data may include any of a quick response (QR) barcode, micro QR barcode, iQR barcode, UPC barcode, MaxiCode barcode, linear barcode, 2-dimensional barcode, or other visual representation of data. In various example embodiments, device 102 may include any of an optical scanner, barcode scanner, QR code scanner, image scanner, charge coupled device, camera-based imager barcode scanner, or laser barcode scanner.

Upon successfully scanning the machine-readable data, device 102 may transmit the machine-readable data to computing device 104. For example, the transmitted machine-readable data may include a text string converted to an object. In various example embodiments, device 102 may communicate with computing device 104 via wireless networking (e.g., Bluetooth (IEEE 802.15.1), WLAN (IEEE 802.11g)), USB connection, serial interface, PS/2, or any other type of interface.

Computing device 104 may be similar to a desktop or laptop computer, and may include one or more of processor 106, memory 108, application 110, SDK 112, object builder 114, and rendering component 116. More specifically, SDK 112, object builder 114, and rendering component 116 may be separate components of application 110, or may be combined.

Application 110 may be a desktop software application configured to access the internet (i.e., web browser). Application 110 may be similar to GOOGLE CHROME, MICROSOFT EDGE, MICROSOFT INTERNET EXPLORER, MOZILLA FIREFOX, and SAFARI.

As an example, the machine-readable data transmitted by device 102 may be received and processed by application 110 using SDK 112, which may further transmit the machine-readable data to object builder 114.

Once the machine-readable data is received from SDK 112, object builder 114 may build various objects. Object builder 114 may also validate the machine-readable data and/or create/publish an event associated with the machine-readable data, for example, an event indicating a scanned barcode (i.e., “Barcode scanned” event). Object builder 114 may also include an event generator (e.g., JavaScript event generator). In some example embodiments, object builder 114 may be an event handler developed based upon JAVASCRIPT. Object builder 114 may then publish the event to rendering component 116.

Rendering component 116 may be an open-source engine or library, such as GOOGLE CHROMIUM, configured to render various websites. Upon receiving the published event, rendering component 116 may perform automated functions. Furthermore, rendering component 116 may subscribe to barcode events associated with the event handler.

In certain example embodiments, rendering component 116 may subscribe to barcode events when a process barcode is scanned; in response, rendering component 116 may automatically begin a process associated with the process barcode; record an operator, date, time, and location associated with the process; and complete the process.

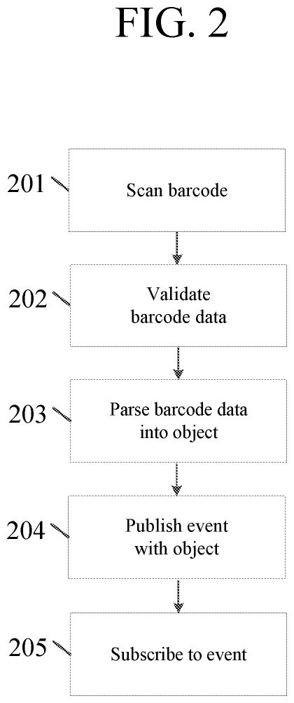

FIG. 2 illustrates an example of a flow diagram of a method that may be performed by a computing device, such as computing device 104 above, according to various example embodiments.

At 201, the method may include receiving barcode data from a scanning device, similar to device 102 described above. The desktop interface may include several components, such as an SDK, object builder, and rendering component (similar to SDK 112, object builder 114, and rendering component 116 above, respectively). The computing device may also run an application, such as a desktop interface. The computing device may be connected to the scanning device, and the barcode data may be received at the SDK.

At 202, the barcode data may be validated to ensure that the data/text is in a certain format, such as JavaScript Object Notation (JSON). For example, the validation may include ensuring that the data is in the following format:

```
{
  “Context”: “Process”,
  “Process”: “STR093DB-HT05”,
  “Sample”: “”,
  “ProcessFlow”: “”,
  “Other”: “”
}
```

At 203, the barcode data may be parsed into an object (e.g., C#object), which may be converted into a JavaScript object. At 204, the object may be published as an event (e.g., “barcodescanned”) with the object. As an example, the object may be published to a rendering component, similar to rendering component 116 above. As a result, a web application rendered inside the rendering component may subscribe to the event and perform further processing.

At 205, the barcodescanned event may be subscribed to. For example, whenever another barcode is scanned, a process start or complete API may be invoked. In addition, necessary parameters (e.g., Operator, Start time, Completed time, location and other metadata) may be passed automatically without any user interaction.

The features, structures, or characteristics of example embodiments described throughout this specification may be combined in any suitable manner in one or more example embodiments. For example, the usage of the phrases “various embodiments,” “certain embodiments,” “some embodiments,” or other similar language throughout this specification refers to the fact that a particular feature, structure, or characteristic described in connection with an example embodiment may be included in at least one example embodiment. Thus, appearances of the phrases “in various embodiments,” “in certain embodiments,” “in some embodiments,” or other similar language throughout this specification does not necessarily all refer to the same group of example embodiments, and the described features, structures, or characteristics may be combined in any suitable manner in one or more example embodiments.

Additionally, if desired, the different functions or procedures discussed above may be performed in a different order and/or concurrently with each other. Furthermore, if desired, one or more of the described functions or procedures may be optional or may be combined. As such, the description above should be considered as illustrative of the principles and teachings of certain example embodiments, and not in limitation thereof.

One having ordinary skill in the art will readily understand that the example embodiments discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of the example embodiments.

### Partial Glossary

JSON JavaScript Object Notation

QR Quick Response

SDK Software Development Kit

UPC Universal Product Code

USB Universal Serial Bus

WLAN Wireless Local Area Network

We claim:

1. A method for integrating a barcode scanner with a web application, comprising:
validating, by a computing device, machine-readable data;
generating, by a computing device, at least one event based upon the validated machine-readable data; and
publishing, by the computing device, the at least one event according to a rendering component.

2. The method of claim 1, wherein the barcode data is based upon a quick response code.

3. The method of claim 1, wherein the rendering component comprises Google Chromium.

4. The method of claim 1, further comprising:
receiving, by the computing device, the machine-readable data from a barcode scanner.

5. The method of claim 1, further comprising:
subscribing, by the computing device, to the at least one event.

6. The method of claim 1, further comprising:
parsing, by the computing device, the barcode data into at least one object.

7. The method of claim 1, wherein the validation comprises validating that the machine-readable data comprises JavaScript Object Notation.

8. A system, comprising:
a scanning device configured to scan machine-readable data;
a computing device comprising:
at least one processor;
at least one memory; and
an application comprising:
a software development kit configured to receive machine-readable data from the scanning device; and
an object builder configured to:
validate the machine-readable data; and
publish an event associated with the machine-readable data; and
a rendering component subscribe to the event and perform further processing.

9. The system of claim 8, wherein the machine-readable data is based upon a quick response code.

10. The system of claim 8, wherein the rendering component comprises Google Chromium.

11. The system of claim 8, wherein the object builder validates that the machine-readable data comprises JavaScript Object Notation.

12. A non-transitory computer-readable medium comprising program instructions stored thereon for performing:
validating machine-readable data;
generating at least one event based upon the validated machine-readable data; and
publishing the at least one event according to a rendering component.

13. The computer-readable medium of claim 12, wherein the barcode data is based upon a quick response code.

14. The computer-readable medium of claim 12, wherein the rendering component comprises Google Chromium.

15. The computer-readable medium of claim 12, further comprising program instructions stored thereon for performing:
receiving, by the computing device, the machine-readable data from a barcode scanner.

16. The computer-readable medium of claim 12, further comprising program instructions stored thereon for performing:
subscribing, by the computing device, to the at least one event.

17. The computer-readable medium of claim 12, further comprising program instructions stored thereon for performing:
parsing, by the computing device, the barcode data into at least one object.

18. The computer-readable medium of claim 12, wherein the validation comprises validating that the machine-readable data comprises JavaScript Object Notation.
